(19) United States
(12) Patent Application Publication
(10) Pub. No.: US 2012/0291891 A1
(43) Pub. Date: Nov. 22, 2012

(54) CONTAINER MADE OF PLASTICS FOR DIALYSIS

(75) Inventors: Frank RITTER, Eppishausen-Weiler (DE); Oliver WOLF, Untermeitingen (DE); Frank FINIS, Augsburg (DE)

(73) Assignee: RITTER GMBH, Schwabmunchen (DE)

(21) Appl. No.: 13/438,514

(22) Filed: Apr. 3, 2012

(30) Foreign Application Priority Data
Apr. 5, 2011 (DE) 10 2011 016 167.8

(51) Int. Cl. F16K 51/00

(52) U.S. Cl. 137/544

(57) ABSTRACT

A rigid container made of plastics for receiving a solid or liquid concentrate for the preparation of a dialysis fluid for use in a dialysis machine, the container consisting of a base part and a lid part and being equipped with a first connector for feeding and a second connector for draining a liquid and for connecting to a dialysis machine, and being otherwise closed or closable in an airtight manner, is characterized in that the second connector is connected to an outlet line (3), the feeding opening of which is arranged near the bottom of the base part.

The present invention relates to a rigid container made of plastics, the container consisting of a base part and a cover plate or a lid part, for receiving a solid or liq-uid concentrate for the preparation of a dialysis fluid for use in a dialysis machine, wherein the container is equipped with a first connector for feeding and a second connector for draining a liquid absorbing the concentrate, and for connection to the dialysis machine, and is otherwise closed or closable in an airtight manner.

Since both the preparation and the transport of liquid concentrates of the dialysis fluid are expensive and costly, due to the fact that mainly only water is transported from the production site to the patient, it has become customary to present preferably powdered concentrates in containers that are connected, via a system of lines, to a water source on the inlet side and to the dialysis machine on the outlet side. With such a system, fresh bicarbonate solution for haemodialysis is continuously provided as needed. By obtaining the bicarbonate solution on the site of use, the problem of carbon dioxide outgassing can also be circumvented.

Such containers are disposable containers that contain the amount of bicarbonate salt, in particular in solid form, necessary for one haemodialysis procedure and can be connected for use with a haemodialysis device by means of a coupling connection. The haemodialysis device then passes the dialysis fluid through the salt container in order to absorb the salt.

From EP 0 575 970 A2, a flexible bag for receiving a liquid concentrate for dialysis is known. At the end of the procedure, the dialysis device extracts the dialysis fluid from the salt container by suction. Because of its flexible shape, the bag is compressed due to the negative pressure in its interior, so that it can be emptied without difficulty. Since the inlet and the outlet of the solution circuit are situated at the same position of the container because of the two-channel connection plug, it is necessary to provide a line duct inside the container from one of the two channels of the connection plug to the opposite end of the container in order to ensure that the liquid solution passes through the whole bicarbonate container. With the known container, this is achieved by a flexible hose projecting from one of the two channels of the connection plug into the interior of the bag and opening at an end of the bag opposite the plug connection. Apart from the high manufacturing costs for the use of a bag, it cannot be ruled out that the free end of the hose projecting into the interior of the bag does not or not anymore maintain its predetermined position in the bag filled with bicarbonate salt, so that the liquid solution only passes through parts of the bag, which could lead to a varying concentration of the bicarbonate solution.

Although they have certain advantages compared to flexible bags, the draining process is difficult with rigid salt containers because the rigid container cannot collapse, so that the fluid in the container can only be extracted partly; for this reason, according to DE 10 2005 060 290 B3 a salt container made of plastics has been provided which allows for a problem-free draining of the salt container by means of the negative pressure generated by the dialysis device.

It is an object of the invention to improve a rigid salt container for haemodialysis in such a way that it allows for optimal feeding of the bicarbonate solution to the dialysis machine.

According to the invention, this object is achieved by the fact that the second connector is connected to an outlet line, the feeding opening, i.e. the bottom-facing aperture, of which is arranged near the bottom of the base part. “Close to the bottom” in the sense of the present invention preferably means that the bottom-facing opening of the outline line is arranged at a distance of less than one-fifth of the height of the base part with respect to the bottom of the base part. The distance between the bottom of the base part and the bottom-facing opening of the outlet line may, e.g., be between 1 mm and 3 cm.

Advantageous developments of the invention result from the sub-claims, the description and the drawings.

According to one embodiment of the invention, the base part of the container preferably has a substantially cylindrical jacket wall, wherein the lid is attached to an open front side of the base part, while the other front side of the container is formed by the bottom of the base part.

In another preferred embodiment, the base part is conically tapered towards its bottom. By this shape, good adaptation to the carrier for receiving the container and good handling properties can be achieved.

Preferably, the cross-section of the base part is configured to have the shape of a circle from which a segment has been cut out.

It is advantageously provided that the base part, at least over a region of its jacket wall, is adapted to the contour of the dialysis machine, or of an aggregate associated with the dialysis machine for feeding the fluid that has been enriched with the concentrate into the dialysis machine.

Advantageously, the connectors of the container are also configured to establish a form-fitting connection with the aggregate or the dialysis machine, respectively, at the same time, particularly with the connectors of the dialysis machine providing the entrance of the fluid and the drain of the fluid enriched by the concentrate.

It is also advantageous if the connectors are incorporated into a flange that laterally projects over the edge of the lid and/or the base part.

Preferably, the lid and the base part are welded together, in particular by ultra-sound welding, or bonded together after the filling with the bicarbonate salt, to allow for an air-tight connection between the base part and the lid.

Advantageously, openings for the first connector that are incorporated into the lid are provided for supplying the water that serves as a solvent for the bicarbonate salt.

In order to prevent foreign bodies from entering during the feeding of the solvent, filter elements are respectively attached to the openings on the inner side of the container.

In an advantageous embodiment of the invention, it is further provided that the filter element is arranged in a cylindrical flange on the side of the lid facing the base part.

Alternatively or additionally, the line connected to the first connector as well as the outlet line are provided with a filter element in the area of their bottom-facing openings.

Preferably, the outlet line is also made of a rigid plastic. Advantageously, it is held by fixing elements attached to the bottom and/or the jacket wail of the base part and/or on the flange, and can be plugged into the base part through the opening on the lid side before the salt is filled into the base part and the latter is closed with the lid.

In order to achieve an airtight connection between the base part and the outlet line on the one hand and between the outlet line and the lid on the other hand, the connector of the outlet line is shaped in a way that during the introduction of the outlet line into the base part it can be inserted in a form-fitting manner onto contours on an upper rim of the base part that is provided for the mounting of the lid. In this case, an embodiment is preferred according to which, in the direction of insertion, the connector has the shape of a triangle that can be inserted between the contours of the base part which form an acute angle between them.

Subsequently, after mounting the lid by welding, in particular by ultrasound welding, or bonding, the connector of the outlet line is connected both to the base part and the lid in an airtight manner.

A filter element is also provided on the underside of the outlet line, in front of its intake opening, in order to prevent the outlet of unsolved bicarbonate particles or other solid particles from the container through the second connector.

Preferably, the outlet line is tapered, for example conically, from the bottom towards the second connector, thereby ensuring an optimal and uniform mixing of the solvent with the bicarbonate solution.

It is further advantageously provided that a venting valve having a venting opening formed into the container wall is arranged on one container wall, in particular in the lid, and that a sealing film is provided which covers said opening on the inside of the container wall and is connected to the container wall by local bonding or welding. The bonding or welding is dimensioned in such a way that the sealing film is broken or detached, at least locally, when a specific pressure difference between the air pressure on the outside of the container and the negative pressure generated by the dialysis device in the interior of the container is reached.

Advantageously, a line is connected to the first connector as well as the outlet line is connected to the second connector wherein the bottom-facing opening of the line, i.e. of a line section or an ascension pipe, that is comprised by the line, is arranged close to the bottom of the base part.

The line connected to the first connector as well as the outlet line are capable of being adapted in a form-fitting manner to the contours of the lid and in a form-fitting manner to an upper edge of the base part that is provided for attaching the lid.

In the following, the invention will be described in more detail on the basis of two exemplary embodiments shown in the accompanying drawings. In the drawings:

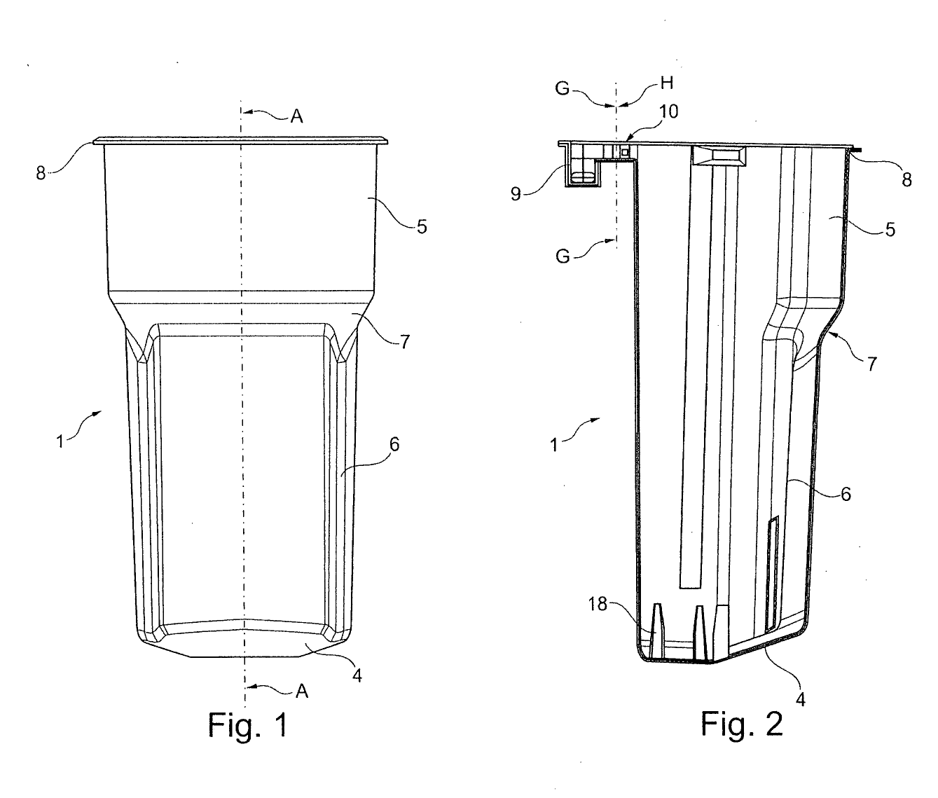

FIG. 1 shows a lateral top view of a base part of a container without lid according to a first embodiment,

FIG. 2 shows a longitudinal section through the base part along a section line A-A from FIG. 1, shown rotated,

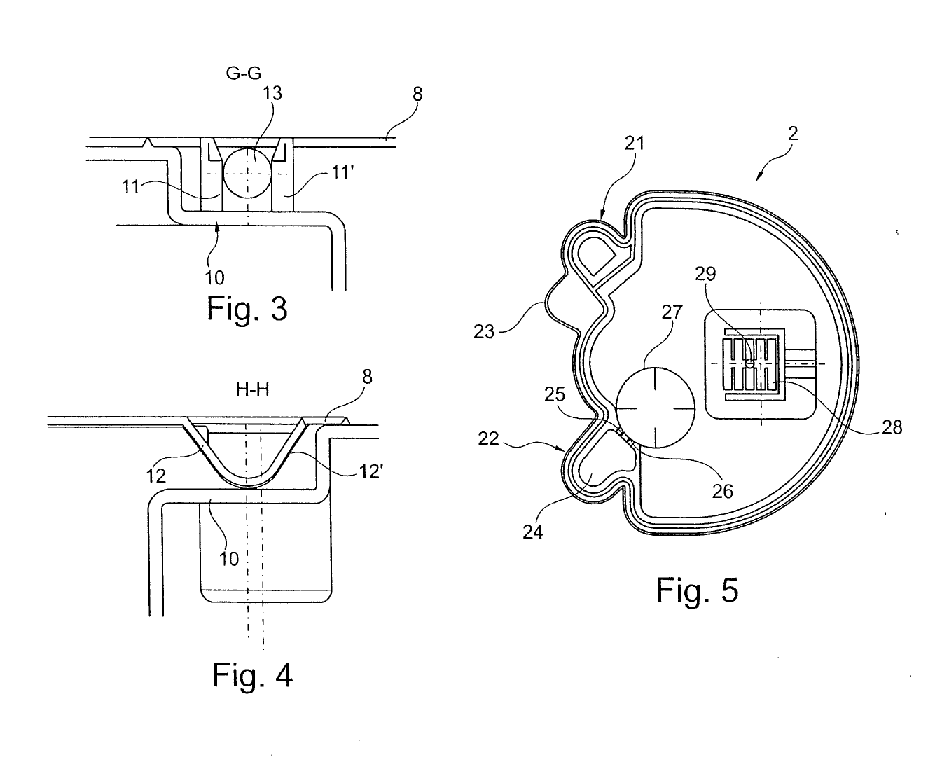

FIG. 3 shows an enlarged view of an area of the flange of the base part on the lid side along a section line G-G from FIG. 2,

FIG. 4 shows an enlarged view of another area of the flange of the base part along a section line H-H from FIG. 2,

FIG. 5 shows a top view of the underside of a lid that can be placed onto the upper side of the base part, corresponding to FIG. 1

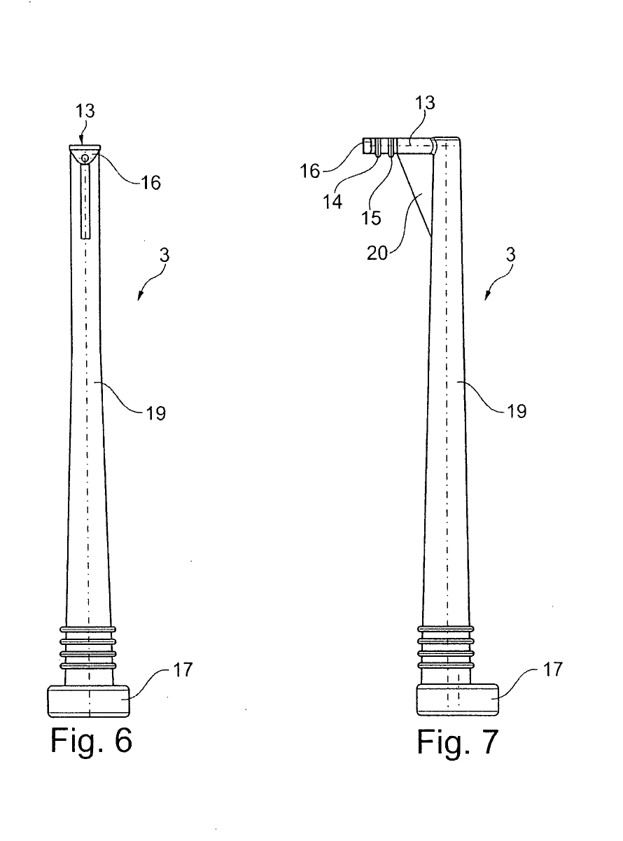

FIG. 6, 7 show two lateral top views, rotated by 90° with respect to each other, of an outlet line that can be inserted into the base part, corresponding to FIG. 1,

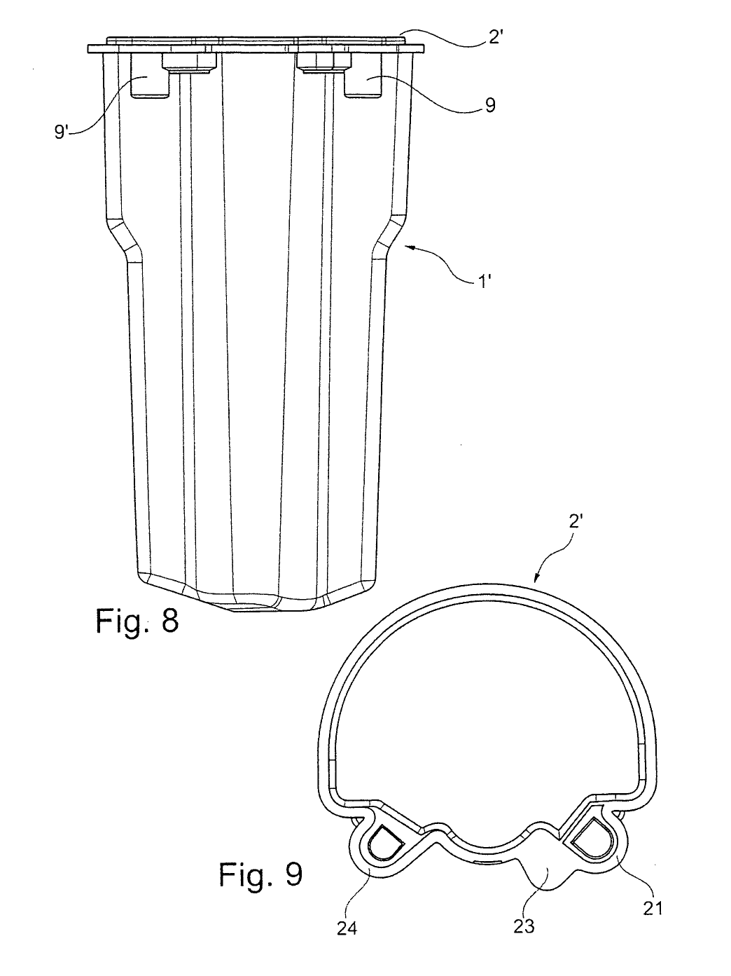

FIG. 8 shows a base part of a container according to a second embodiment,

FIG. 9 shows a lid adapted to the base part, corresponding to FIG. 8,

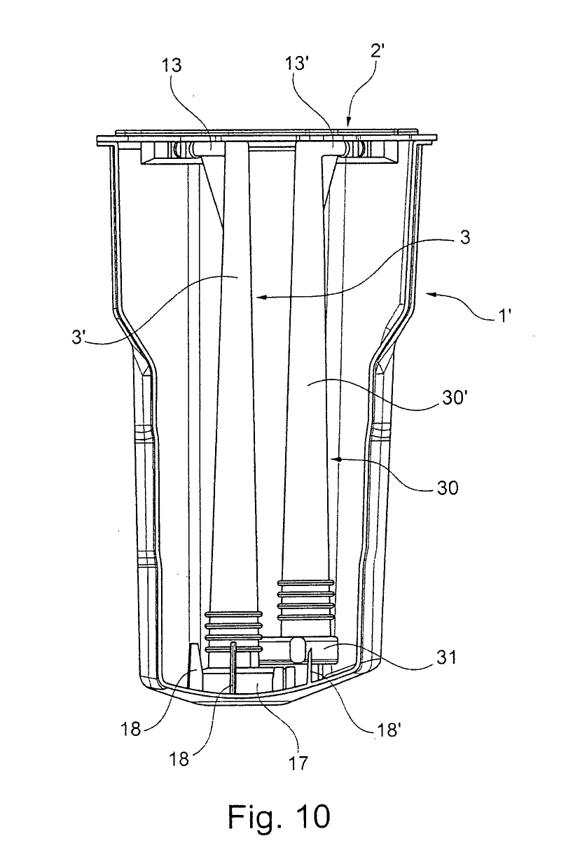

FIG. 10 shows the base part corresponding to FIG. 8, comprising two ascension pipes, in a top view together with the lid,

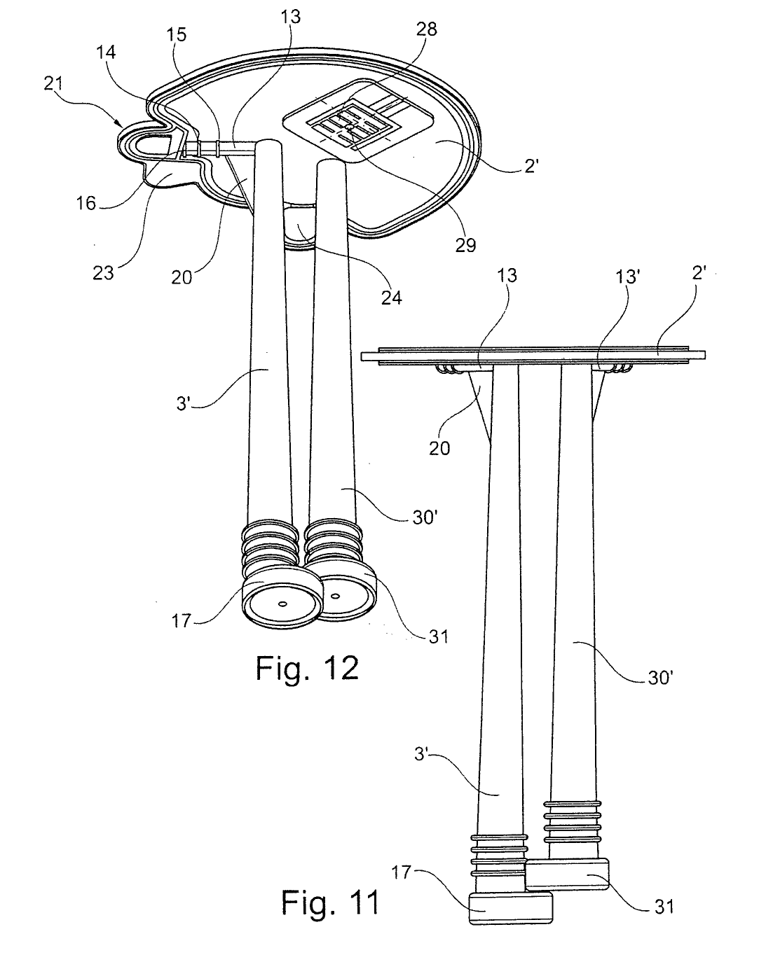

FIG. 11 shows the ascension pipes in their positions underneath the lid and

FIG. 12 shows a perspective view of the ascension pipes and the lid from below.

A rigid container made of plastics according to a first embodiment of the invention comprises a base part 1 (FIGS. 1 to 4) and a lid 2 (FIG. 5). An outlet line 3 (FIGS. 6, 7) can be inserted into the base part 1 and fixed on a bottom 4 of the base part 1, the bottom being slightly arched upwards from its center.

The base part 1 has a substantially cylindrical shape and comprises an upper and a lower partition 5 and 6, respectively, which are connected to one another via a slanting intermediate piece 7. In addition, the partitions 5, 6 have a slightly conical shape, wherein their horizontal cross-section is enlarged towards the top.

Preferably, the partitions 5, 6 have additional contours, in particular extending in a vertical direction, which, on the one hand, allow for a simple manual positioning, e.g., by means of recessed grips, of the container in the dialysis machine or in any other mount. On its upper rim, the base part 1 has a circumferential flange 8 which serves for the mounting of the lid 2. On the flange 8 or in the area of the flange 8, two or more connecting pieces are provided to establish a connection for the supply of water as a solvent for the bicarbonate salt introduced into the base part 1, or for the outlet of the solution loaded with the bicarbonate salt and led out of the base part 1 via the outlet line, respectively; of those two, only the connecting piece 9 serving for the outlet is shown in FIG. 2.

An intermediate piece 10 is arranged between the outer wall and the connecting piece 9, the intermediate piece being equipped with holding contours 11, 11′ and 12, 12′ for the form-fitting and/or force-fitting positioning and holding of an outlet 13 of the outlet line 3. During use of the container with the dialysis machine, the outlet 13 is substantially in a horizontal position and presents contours 14, 15 on its out-side which can be connected to contours on the intermediate piece 10 in a form-fitting or force-fitting manner when the outlet line 3 is inserted into the base part 1. The contours 12, 12′ together define the shape of an isosceles triangle wherein the angle area between the contours 12, 12′ is rounded. The contours 12, 12′ are shaped in such a way that they are adapted in a form-fitting manner to the triangular cross-section of an outlet end 16. Thus, the outlet 16 can be welded together with the contours 12, 12′ and with the underside of the lid 2, in particular with a thickening provided on the underside of the same, in an airtight manner by ultra-sound welding.

On its foot end, the outlet line 3 has a cylindrical attachment piece 17 which can be slid in a form-fitting and force-fitting manner between guiding and holding ribs 18 attached to the bottom 4 when the outlet line 3 is inserted into the base part 1. The cylindrical attachment piece 17 receives a filter which serves for the cleaning of the fluid flowing out of the container into the outlet line 3. The bottom side of the attachment piece 17 forms the bottom-facing aperture of the outlet line 3.

A conical line section 19 that is tapered upwards is connected above the attachment piece 17, the line section serving to ensure an optimal mixing of the salt in the solution when the container is inserted into a dialysis machine and a dialysis procedure is performed. The line section 19 merges with the outlet 13 at a right angle. A reinforcing rib 20 is provided between the line section 19 and the outlet 13.

The lid 2 has projections 21, 22 adapted to the shape of the connecting pieces, wherein the outlet 13 opens into the connector 9 under the projection 21. A connector (not shown) is also provided under the projection 22 on the base part 1. Both connectors, in particular together with a further connecting piece that can be attached below a projection 23 attached to the base part 1, are also adapted, in particular in connection with other parts of the container, preferably the bottom 4, to establish a form-fitting connection between the container and the dialysis machine or any other apparatus carrying the container during dialysis.

The lid 2 is configured in a way that water or any other liquid supplied in an inlet area 22 is introduced into the interior of the container through two channels 25, 26 via a filter arranged in a cylindrical mount 27 also attached to the underside of the lid 2. The fluid then passes through the bicarbonate salt supply introduced into the container and subsequently exits the container, saturated or enriched with bicarbonate salt, via the outlet line 3.

The lid 2 is equipped with a venting valve 28 to allow the complete draining of the salt container during the extraction of the dialysis fluid from the container after the rinsing out of the salt filling from the salt container connected to a dialysis device, by enabling the introduction of outside air under the influence of negative pressure.

As shown in FIG. 5, the venting valve 28 comprises an opening 29 formed into the wall of the lid 2, and a seal made of a piece of film attached to the inner side of the lid 2, closing off the opening 29 and being connected, by bonding or ultrasound welding, to the wall around the opening 29 in the shape of a wreath.

When, during the use of the salt container in a dialysis device, the salt container is rinsed with the dialysis fluid in order to wash out the bicarbonate salt, the seal is pressed against the venting opening 29, in addition to the bonding or welding connection, in a sealing manner by the overpressure in the salt container. However, a negative pressure is generated in the salt container during the extraction of the dialysis fluid. If the negative pressure in the salt container reaches a specific threshold value, the seal is detached from the underside of the lid, at least in part, due to the atmospheric pressure reaching the seal through the venting opening 29, so that outside air can enter the container through the venting valve 28 and the fluid thus can be extracted completely.

It will be understood that the venting valve 28 can be arranged in any other position of the container wall instead of on the lid 2.

According to a second embodiment (FIGS. 8 to 12) for flowing in and for draining the fluid, i.e. for the outlet line 3 and a line 30, ascensions pipes 19 and 19′, respectively, are provided for each of the lines 30, 3 in a base part 1′ wherein, below a lid 2′, an outlet 13 and an outlet 13′ are connected to the ascension pipes 19 and 19′, respectively. The outlets 13, 13′ are arranged in parallel to the bottom side of the lid 2′. The ascension pipes 19, 19′ are arranged in parallel; they may, however, be arranged concentrically.

Both outlets 13, 13′ are shaped as shown by FIGS. 6, 7, 11 and 12. Both ascension pipes 3′, 30′ narrow up and comprise a cylindrical attachment piece 17, 31 at the bottom, respectively, for receiving a filter. Both lines 3, 30 are connected and hermetically sealed by means of the outlets 13, 13′, respectively to connecting pieces 9, 9′, respectively, positioned at the outer face of the container. The connecting pieces 9, 9′ are to be connected hermetically to the dialysis machine for inserting of a fluid that takes up the concentrate contained in the container 1′ by means of the connecting piece 9 and for draining the fluid enriched by the concentrate by means of the connecting piece 9′. Each of the lines 3, 30 is fit for extracting a remnant of fluid in the bottom range of the base part 1′ after the end of the dialysis process.

The outlets 13, 13′ are inserted in corresponding holding fixtures of the base part 1′ that are formed as shown by FIGS. 3, 4 and abut against the corresponding connecting pieces 9, 9′. The lid 2′ is substantially formed as the lid 2 as shown by FIG. 5. The lid 2′ distinguishes from lid 2 in that lid 2′ does not comprise a cylindrical mount 27 for taking up a filter.

Both lines 3, 30 or the cylindrical attachment pieces 17, 31 are fixed at their bottom faces by means of guiding and holding ribs 18, 18′, respectively.

Pursuant the invention and according to both embodiments of the invention, instead of rigid ascension pipes flexible ascension tubes may be used.

### LIST OF REFERENCES

1 Base part
1′ Base part
2 Lid
2′ Lid
3 Outlet line
4 Bottom
5 Partition
6 Partition
7 Intermediate piece
8 Flange
9 Connector connecting piece
9′ Connector connecting piece
10 Intermediate piece
11 Holding contour
11′ Holding contour
12 Holding contour
12′ Holding contour
13 Outlet
14 Contour
15 Contour
16 Outlet end
17 Attachment piece
17′ Attachment piece
18 Guiding and holding ribs
18′ Guiding and holding ribs
19 Line section or ascension pipe
19′ Line section or ascension pipe
20 Reinforcing rib
21 Projection
22 Projection
23 Projection
24 Inlet area
25 Channel
26 Channel
27 Cylinder mount
28 Venting valve
29 Opening
30 Line
30′ Ascension pipe

1. A rigid container made of plastics, consisting of comprising a base part and a cover plate or a lid part, for receiving a solid or liquid concentrate for the preparation of a dialysis fluid for use in a dialysis machine, wherein the container is equipped with a first connector for feeding and a second connector for draining a liquid absorbing the concentrate and for connection to the dialysis machine, and is otherwise closed or closable in an airtight manner,
wherein
the second connector is connected with an outlet line, the bottom-facing feeding opening of which is arranged near the bottom of the base part.

2. The container according to claim 1,
wherein
the first connector is connected with a line the bottom-facing opening of which is arranged near the bottom of the base part.

3. The container according to claim 1,
wherein
the base part of the container has a substantially cylindrical jacket wall and that the lid is attached to an open front side of the base part, while the other front side of the container is formed by the bottom of the base part.

4. The container according to claim 1,
wherein
the base part is conically tapered towards its bottom.

5. The container according to claim 1,
wherein
the base part has the cross-sectional shape of a circle from which a segment has been cut out.

6. The container according to claim 1,
wherein
the base part, at least over a region of its jacket wall, is adapted to the contour of the dialysis machine, or of an aggregate associated with the dialysis machine for feeding the fluid enriched with the concentrate into the dialysis machine.

7. The container according to claim 1,
wherein
the connectors of the container are at the same time configured to establish a form-fitting connection with the aggregate or the dialysis machine, respectively.

8. The container according to claim 1,
wherein
the connectors are incorporated into a flange that laterally projects over the edge of the lid and/or the base part.

9. The container according to claim 1,
wherein
the lid and the base part are welded together, in particular by or that the lid and the base part are bonded together.

10. The container according to claim 1,
wherein
the first connector comprises openings or channels that are incorporated into the lid.

11. The container according to claim 1,
wherein
at least one of the line or the outlet line comprises a filter element.

12. The container according to claim 11,
wherein
the filter element adjoins the openings on the inner side of the container or that the filter element is arranged in a cylindrical flange on the side of the lid facing the base part or that the filter element is positioned in at least one of the bottom-facing attachment pieces of the line or the outlet line.

13. The container according to claim 1,
wherein
the ascension pipes are made of a rigid or a flexible plastic.

14. The container according to claim 1, wherein
the connector of the outlet line is shaped in such a way that during the introduction of the outlet line into the base part it can be inserted in a form-fitting manner onto contours on an upper rim of the base part that is provided for the mounting of the lid.

15. The container according to claim 14,
wherein
the connector has the shape of a triangle that can be inserted between the contours which form an acute angle between them.

16. The container according to claim 14,
wherein
after mounting the lid by welding, or bonding, the connector of the outlet line can be connected both to the base part and the lid in an airtight manner.

17. The container according to claim 13,
wherein
the outlet line and the line is held by fixing elements or guiding and holding ribs attached to the bottom and/or the jacket wall of the base part and/or on the flange, and can be plugged into the base part.

18. The container according to claim 13,
wherein
a filter element is arranged on the underside of the outlet line.

19. The container according to claim 13,
wherein
the ascensions pipes are tapered from the bottom towards the first connector and the second connector.

20. The container according to claim 1,
wherein
on one container wall, a venting valve having a venting opening formed into the container wall is provided, and that a sealing film is provided which covers said opening on the inside of the container wall and is connected to the container wall by local bonding or welding, wherein the bonding or welding is dimensioned in such a way that the sealing film is broken at least locally when a specific pressure difference between the air pressure on the outside of the container and the negative pressure generated by the dialysis device in the interior of the container is reached.
